(19) United States
(12) Patent Application Publication
(10) Pub. No.: US 2026/0269986 A1
(43) Pub. Date: Sep. 10, 2026

(54) METHODS FOR SUPPORTING A SEMI-HYBRID RETRANSMISSION MECHANISM IN MOBILE COMMUNICATIONS

(71) Applicant: MediaTek Singapore Pte. Ltd., Singapore (SG)

(72) Inventors: Pradeep JOSE, Cambridge (GB); Mehmet KUNT, Cambridge (GB); Mukesh CHOUHAN, Cambridge (GB)

(21) Appl. No.: 19/166,210

(22) PCT Filed: Jun. 6, 2024
(86) PCT No.: PCT/CN2024/097782

§ 371 Date: Sep. 17, 2025

Related U.S. Application Data
(60) Provisional application No. 63/506,392, filed on Jun. 6, 2023.

(51) Int. Cl. H04L 1/1812; H04L 1/1867; H04L 5/00

(52) U.S. Cl. CPC H04L 1/1812; H04L 1/1874; H04L 5/0044

(57) ABSTRACT

Various solutions for supporting a semi-hybrid retransmission mechanism in mobile communications are described. An apparatus may perform an UL transmission of at least one first transport block (TB) associated with at least one hybrid automatic repeat request (HARQ) process to the network node. The apparatus may receive feedback information corresponding to the UL transmission from the network node. The apparatus may perform an UL retransmission of data from the first TB to the network node using a second TB in an event that the feedback information indicates the UL transmission being unsuccessful and indicates a non-HARQ type of retransmission.

### CROSS REFERENCE TO RELATED PATENT APPLICATION(S)

The present disclosure is part of a non-provisional application claiming the priority benefit of U.S. Provisional Patent Application No. 63/506,392, filed 6 Jun. 2023, the content of which herein being incorporated by reference in its entirety.

### TECHNICAL FIELD

The present disclosure is generally related to mobile communications and, more particularly, to supporting a semi-hybrid retransmission mechanism in mobile communications.

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using a plurality of cells forming a radio access network. The BS may support the operations of the plurality of cells, and each cell may be operable to provide services to at least one user equipment (UE) within its radio coverage. Specifically, each cell may provide services to serve one or more UEs within its radio coverage based on at least one downlink control information (DCI), where a radio coverage of one cell may overlap with another radio coverage of other cell(s). Typically, a cell may schedule multiple uplink/downlink (UL/DL) resources (e.g., transport blocks (TB)) to one UE within its radio coverage by a DCI for performing UL/DL transmissions.

In the 4^{th} generation (4G) Long-Term Evolution (LTE) or 5^{th} generation (5G) New Radio (NR) technology, data reliability is achieved using a combination of the HARQ mechanism and the ARQ mechanism. However, there are several drawbacks in the HARQ and ARQ mechanisms. For example, in the HARQ mechanism, the acknowledgement (ACK) or non-acknowledgement (NACK) feedback for DL data is transmitted on the physical uplink control channel (PUCCH) which faces significant reliability issues, one of them being the high false alarm rate (e.g., a NACK may be misinterpreted as an ACK). In addition, the limited number of HARQ processes can result in transmission stalls if they are all occupied, and in which case the HARQ mechanism needs to give up on retransmissions and rely on higher layer(s) (e.g., the radio link control (RLC) layer, and/or over-the-top transport protocols) to meet reliability targets. On the other hand, in the ARQ mechanism, retransmissions are triggered based on timers. As the ARQ mechanism runs on top of the HARQ mechanism, it needs to first wait for the HARQ procedure to complete before it can be triggered. As such, the timers need to be modelled based on the worst-case HARQ delays to avoid parallel ARQ and HARQ retransmission of the same data. It is an inflexible design that keeps attempting retransmissions of data until it has been successfully acknowledged. These retransmissions will carry on even if the data is late (i.e., this data has exceeded its delay budget), and there is no means to give up on this data's transmission. This results in large windows to manage in the receiver of unacknowledged data (e.g., up to 131072 packet data units (PDUs) in NR).

For some emerging traffic scenarios, such as XR (extended reality), a low-latency high-throughput requirement is stipulated, aiming to achieve a reliability target within fixed latency-bounds (e.g., 10 to 30 milli-seconds (ms)). Given that the HARQ mechanism offers poor reliability with good latency performance and the ARQ mechanism offers good reliability with poor latency performance, the legacy design using the combination of the HARQ and ARQ mechanisms will not work well for the low-latency high-throughput traffic. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to the inefficiency issues with the legacy design using the combination of the HARQ and ARQ mechanisms.

In one aspect, a method may involve an apparatus performing an UL transmission of at least one first TB associated with at least one HARQ process to the network node. The method may also involve the apparatus receiving feedback information corresponding to the UL transmission from the network node. The method may further involve the apparatus performing an UL retransmission of data from the first TB to the network node using a second TB in an event that the feedback information indicates the UL transmission being unsuccessful and indicates a non-HARQ type of retransmission.

In one aspect, a method may involve a network node scheduling, to an apparatus, at least one first TB associated with at least one HARQ process. The method may involve the network node receiving an UL transmission from the apparatus for the HARQ process using the first TB. The method may also involve the network node transmitting feedback information corresponding to the UL transmission to the apparatus, wherein the feedback information indicates the UL transmission being unsuccessful and indicates a non-HARQ type of retransmission. The method may further involve the network node receiving an UL retransmission from the apparatus of data from the first TB using a second TB.

In one aspect, a method may involve a network node scheduling, to an apparatus, a DL transmission of at least one first TB associated with at least one HARQ process. The method may involve the network node performing the DL transmission to the apparatus for the HARQ process using the first TB. The method may also involve the network node receiving feedback information corresponding to the DL transmission from the apparatus, wherein the feedback information indicates the DL transmission being unsuccessful. The method may further involve the network node performing a DL retransmission to the apparatus of data from the first TB using a second TB in an event that at least one condition is met.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5 G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of the semi-hybrid retransmission mechanism realized in a protocol stack in accordance with an implementation of the present disclosure.

FIG. 3 is a diagram depicting an example scenario of transmitter operations applying the semi-hybrid retransmission mechanism in accordance with an implementation of the present disclosure.

FIG. 4 is a diagram depicting an example scenario of transmitter operations applying the semi-hybrid retransmission mechanism in accordance with another implementation of the present disclosure.

FIG. 5 is a diagram depicting an example scenario of sharing HARQ processes and buffers in accordance with an implementation of the present disclosure.

FIG. 6 is a diagram depicting an example scenario of enhancements on HARQ feedback reliability in accordance with an implementation of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of another example process in accordance with an implementation of the present disclosure.

FIG. 10 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to supporting a semi-hybrid retransmission mechanism in mobile communications. According to the present disclosure, a number of possible solutions may be implemented separately or jointly. That is, although these possible solutions may be described below separately, two or more of these possible solutions may be implemented in one combination or another.

In the 4G LTE or 5G NR technology, data reliability is achieved using a combination of the HARQ and ARQ mechanism. As a first step, the HARQ mechanism offers low-level reliability for all TBs, i.e., TBs are acknowledged, and in case of failures are retransmitted. Retransmissions of TBs can be soft-combined with original transmissions to improve decoding confidence. The implication here is that a TB cannot change (in terms of its TB size) across retransmissions. After a number of HARQ retransmission attempts (typically 4 to 5 retransmissions), the TB is given up and then the ARQ mechanism comes into play. With the ARQ mechanism, each packet is associated with a sequence number (SN) and each SN is acknowledged by the receiver. On reception of this feedback, the transmitter attempts retransmissions for those unacknowledged packets. However, as mentioned previously, there are several drawbacks in the HARQ and ARQ mechanisms. As such, the legacy design using the combination of the HARQ and ARQ mechanisms will not work well for certain emerging traffic with low-latency high-throughput requirement. Accordingly, the present disclosure proposes schemes to support a semi-hybrid retransmission mechanism, to meet the low-latency high-throughput requirement of certain emerging traffic scenarios (e.g., XR).

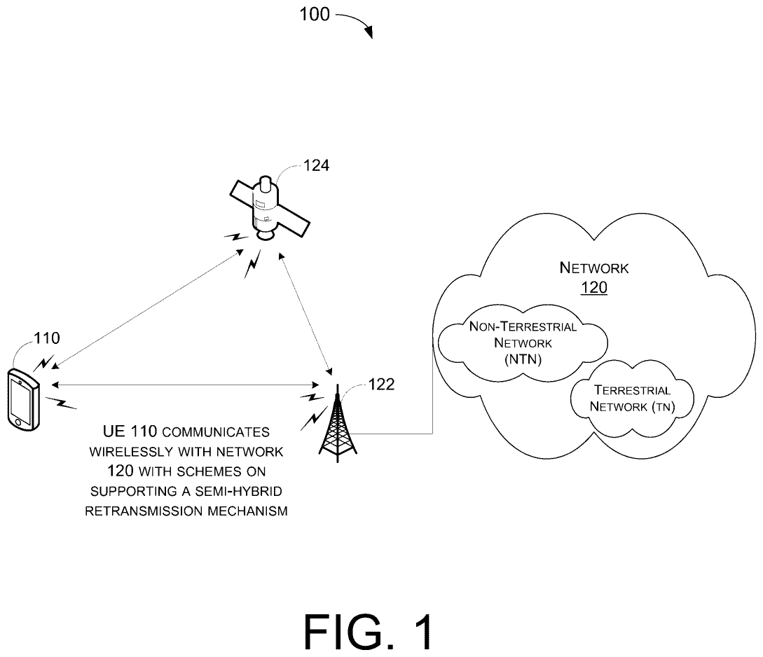

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 122 (e.g., an evolved Node-B (eNB), a Next Generation Node-B (gNB), a distributed unit (DU) or a centralized unit (CU) of an eNB/gNB, or a transmission/reception point (TRP)) and/or a non-terrestrial network node 124 (e.g., a satellite). For example, the terrestrial network node 122 and/or the non-terrestrial network node 124 may form an NTN serving cell for wireless communication with the UE 110. NTN enables data connectivity beyond terrestrial cellular tower coverage (i.e., TN), and it generally refers to a network that uses radio frequency (RF) and information processing resources carried on high, medium and low orbit satellites or other high-altitude communication platforms to provide communication services for UEs (e.g., UE 110). In such communication environment, the UE 110, the network 120, and the terrestrial network node 122 and/or the non-terrestrial network node 124 may implement various schemes pertaining to supporting a semi-hybrid retransmission mechanism (or called a standalone HARQ (SHARQ) mechanism) in mobile communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

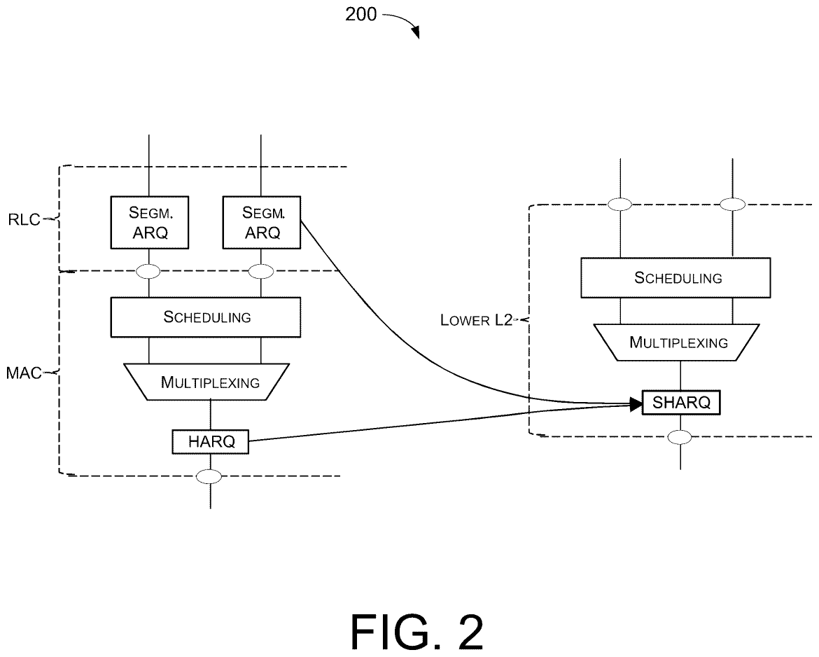

FIG. 2 illustrates an example scenario 200 of the semi-hybrid retransmission mechanism realized in a protocol stack in accordance with an implementation of the present disclosure. The legacy design, as shown in the left part of FIG. 2, utilizes the combination of the ARQ mechanism (e.g., provided at the radio link control (RLC) layer) and the HARQ mechanism (e.g., provided at the medium access control (MAC) layer) to achieve data reliability. On the other hand, as shown in the right part of FIG. 2, a single mechanism, i.e., the SHARQ mechanism, is introduced to achieve data reliability in the protocol stack of the present disclosure. Accordingly, by applying the SHARQ mechanism instead of the ARQ and HARQ mechanisms separately, reliable data transfer may be realized with better latency and better efficiency, e.g., in terms of processing complexity, memory utilization, and power consumption.

Under a first proposed scheme in accordance with the present disclosure, the transmitter (e.g., a UE in UL communications, or an eNB/gNB/DU/CU/TRP/satellite in DL communications) is allowed to rearrange MAC service data units (SDUs) without losing data when TB size needs reducing (e.g., for channel degradation, or network congestion, etc.), i.e., the transmitter is provided with an on-demand retransmission which supports more scheduling flexibility and enables faster retransmissions that favor delay-sensitive traffic. Specifically, for the case of UL communications, a UE may receive a configured grant (e.g., via a radio resource control (RRC) signaling) or a dynamic grant (e.g., via a DCI) from a network node (e.g., eNB/gNB/DU/CU/TRP/satellite) of a wireless network (e.g., 5G network), wherein the configured/dynamic grant indicates a scheduling of an UL transmission of at least one first TB associated with at least one HARQ process. The UE may perform the UL transmission of the first TB associated with the HARQ process to the network node. Then, the UE may receive feedback information corresponding to the UL transmission from the network node. In some implementations, the network node may determine the type of retransmission based on channel condition or network loading. For example, if a channel degradation or a network congestion is detected, the network node may determine the feedback information to indicate a non-HARQ type of retransmission. Otherwise, if there's no channel degradation or network congestion being detected, the network node may determine the feedback information to indicate a HARQ type of retransmission (i.e., retransmit using the first TB and enable soft combining). After that, the UE may perform an UL retransmission to the network node of data from the first TB using a second TB in an event that the feedback information indicates the UL transmission being unsuccessful (e.g., a NACK) and indicates a non-HARQ type of retransmission. Specifically, the second TB is different in size from the first TB.

On the other hand, for the case of DL communications, a network node (e.g., eNB/gNB/DU/CU/TRP/satellite) may transmit a configured/dynamic grant to a UE, wherein the configured/dynamic grant indicates a scheduling of a DL transmission of at least one first TB associated with at least one HARQ process. The network node may perform the DL transmission to the UE for the HARQ process using the first TB. Then, the network node may receive feedback information corresponding to the DL transmission from the UE, wherein the feedback information indicates the DL transmission being unsuccessful (e.g., a NACK). After that, the network node may perform a DL retransmission to the UE of data from the first TB using a second TB in an event that at least one condition (e.g., a channel degradation or a network congestion is detected) is met. Specifically, the second TB is different in size from the first TB.

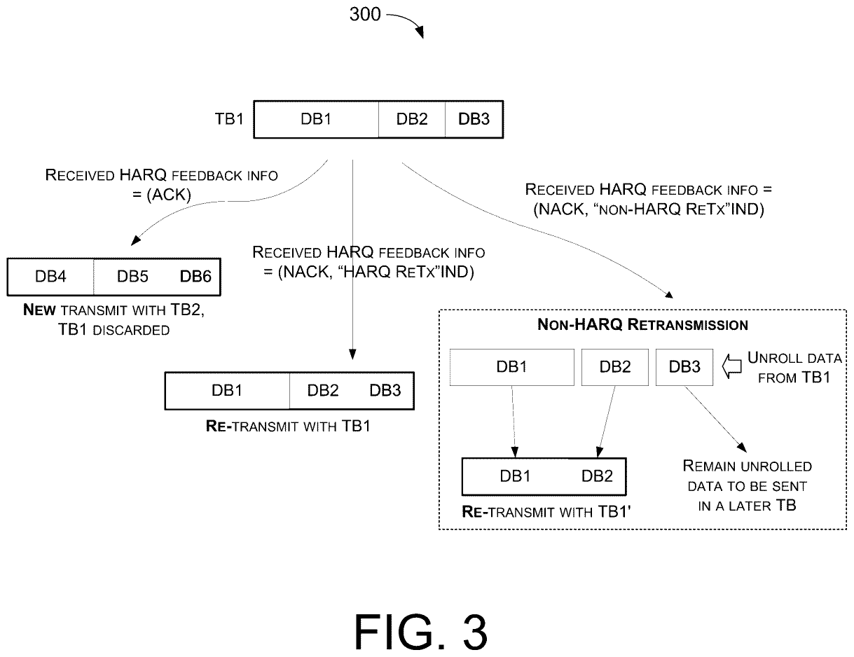

FIG. 3 illustrates an example scenario 300 of transmitter operations applying the semi-hybrid retransmission mechanism in accordance with an implementation of the present disclosure. Scenario 300 involves different transmission (Tx) operations depending on the content of the received HARQ feedback information corresponding to the transmitted TB1 which may include several data blocks (DBs) (denoted as DB1 to DB3 in FIG. 3). In one example, different DBs may be delivered via different logical channels (LCHs). In the case of the received HARQ feedback information including an ACK (i.e., all SDUs in TB1 successfully delivered), the transmitter (e.g., a UE or a network node such as eNB/gNB/DU/CU/TRP/satellite) may perform a new transmission using a new TB (denoted as TB2 in FIG. 3) and discard TB1. In the case of the received HARQ feedback information including a NACK (i.e., none of SDUs in TB1 successfully delivered) and a “HARQ ReTx” indication (i.e., an indication to retransmit TB1 and enable soft combining), the transmitter may perform a retransmission using the same TB, i.e., TB1. In the case of the received HARQ feedback information including a NACK and a “non-HARQ ReTx” indication (i.e., an indication to recover SDUs from TB1 to be retransmitted in a new TB1′), the transmitter may recover/unroll data from TB1 and perform a retransmission using TB1′ which includes a subset of data recovered/unrolled from TB1 (e.g., TB1′ includes DB1 and DB2). In one example, TB1′ is smaller in size than TB1. Additionally, or optionally, the transmitter may store the rest of the data recovered/unrolled from TB1 (e.g., DB3) back to the transmit buffer to be transmitted in a later TB (i.e., in subsequent UL transmission).

Under a second proposed scheme in accordance with the present disclosure, the transmitter (e.g., a UE in UL communications, or an eNB/gNB/DU/CU/TRP/satellite in DL communications) is allowed to discard stale data, thereby avoiding head-of-line blocking (which exists in the ARQ mechanism) to protect delay-sensitive traffic. Specifically, on recovering/unrolling data from a previously sent TB for the non-HARQ type of retransmission, the transmitter may determine whether the data exceeds its delay budget (e.g., packet delay budget (PDB) or packet data unit (PDU) set delay budget (PSDB)). If the data exceeds its delay budget, the transmitter may discard this data, i.e., retransmission of this data may not be attempted further, and this may make way for the transmission of other data which does not exceed their delay budget. In one example, this delay budget may be modeled by using packet data convergence protocol (PDCP) discard timer. On the expiry of the PDCP discard timer for some data, this data is discarded from the transmit buffer used for its retransmission. In one example, if the delay budget is set to infinity, the acknowledge mode (AM) behavior in NR is replicated. In another example, always discarding/dropping data on recovery from a TB replicates unacknowledged mode (UM) behavior. The data discard may act as a trigger for a buffer status report (BSR), since the size of buffered data has changed. Additionally, or optionally, the data discard may act as a trigger for a status report to inform the receiver of holes in the sequence number space corresponding to the discarded data.

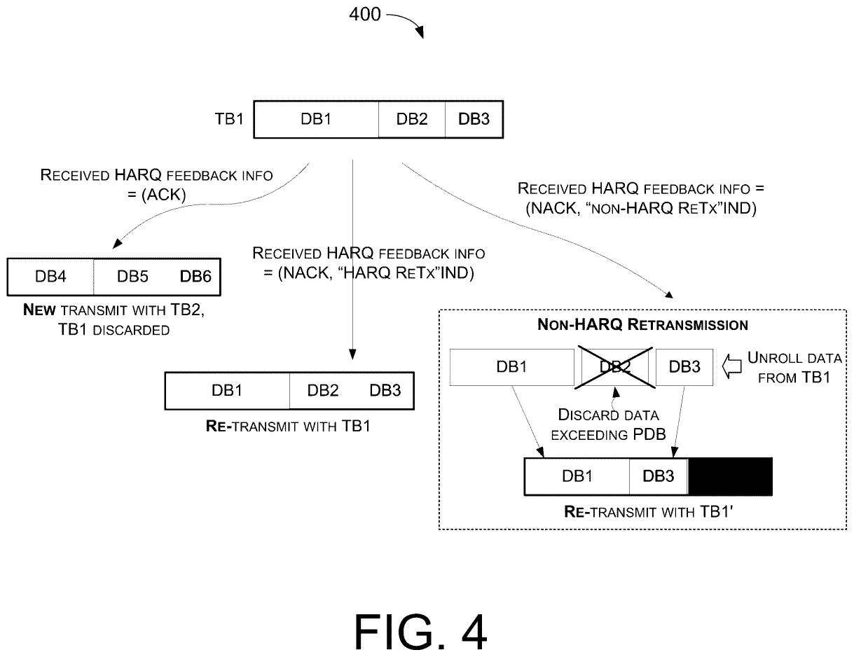

FIG. 4 illustrates an example scenario 400 of transmitter operations applying the semi-hybrid retransmission mechanism in accordance with another implementation of the present disclosure. Similar to FIG. 3, in the case of the received HARQ feedback information including an ACK or including a NACK and a “HARQ ReTx” indication, the same transmitter operations apply. Yet in the case of the received HARQ feedback information including a NACK and a “non-HARQ ReTx” indication, the transmitter may discard the data (e.g., DB2) exceeding the delay budget (e.g., PDB) when recovering/unrolling data from TB1. Next, the transmitter may perform a retransmission using TB1′ which includes a subset of data (e.g., DB1 and DB3) recovered/unrolled from TB1, and optionally new data (e.g., DB4) from the head of the transmit buffer.

Under a third proposed scheme in accordance with the present disclosure, the transmitter (e.g., a UE in UL communications, or an eNB/gNB/DU/CU/TRP/satellite in DL communications) is allowed to share HARQ processes (PIDs) and buffers across carriers (e.g., within the same DU), thereby avoiding stalling of HARQ processes, i.e., to avoid the processing to maintain long tail in RLC and enable efficient data handling implementation. Typically, the maximum number of carriers will be used when in good channel conditions, and the UE does not expect stalling of HARQ processes to occur. However, when in poor channel conditions, more HARQ retransmissions can be foreseen, and at the same time, it is unlikely that the maximum number of carriers will be used when in such poor channel conditions. That is, HARQ processes stalling often tends to occur in this situation. Accordingly, by sharing HARQ processes across carriers, more HARQ processes may be available and a small ARQ window may be replicated (i.e., there's no need to have long RLC windows as no lower layer turnaround time to consider). Moreover, by sharing HARQ buffers across carriers, the constraints on bytes in-flight may be reduced. At peak data rate, a HARQ buffer usually fills up quickly but empties quickly as well to sustain peak rate, while at low data rate, HARQ buffer may fill up slowly to delay stalls.

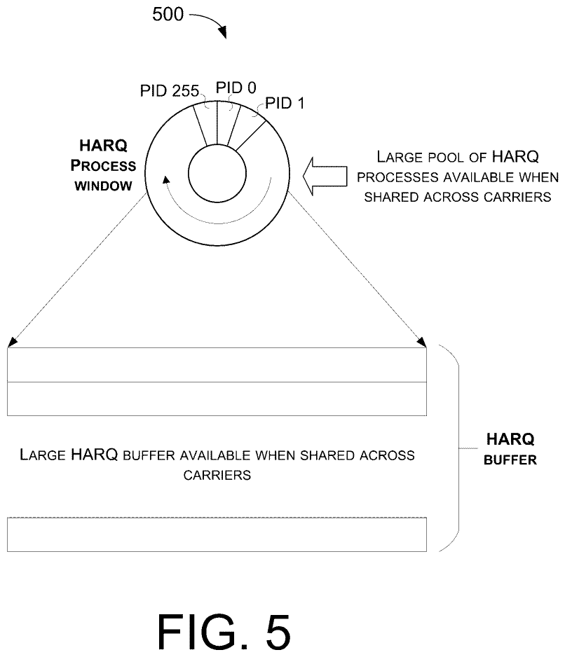

FIG. 5 illustrates an example scenario 500 of sharing HARQ processes and buffers in accordance with an implementation of the present disclosure. Scenario 500 involves multiple HARQ processes and multiple HARQ buffers that are shared across carriers. As shown in FIG. 5, a large pool of HARQ processes is available when these HARQ processes are shared across carriers, and the corresponding HARQ process window (e.g., window size=256 (HARQ processes)) replicates a small ARQ window when compared to a typical ARQ window (e.g., window size=131072 (PDUs)). In addition, a large HARQ buffer is available when these HARQ buffers are shared across carriers. Accordingly, by sharing HARQ processes and buffers across carrier, more HARQ processes are available to reduce the probability of HARQ processes stalling, and more HARQ buffers are available to delay stalls.

Under a fourth proposed scheme in accordance with the present disclosure, additional physical uplink shared channel (PUSCH)-based HARQ status reporting is introduced to enhanced HARQ feedback reliability. This would use a longer cyclic redundancy check (CRC) that provides stronger protection against misinterpretation of the HARQ feedback. For example, the HARQ feedback may be sent using a MAC control element (CE) on the PUSCH. In one example, this feedback may be triggered based on certain events (i.e., event-based triggering), e.g., based on the use of every N^{th} HARQ process or every N^{th} TB to provide the status of the last N HARQ processes or last N TBs. In another example, this feedback may be triggered on demand (i.e., demand-based triggering), e.g., by an explicit indication or on last DL data transmission. Alternatively, to enhanced HARQ feedback reliability, the transmitter may be allowed to always report last N HARQ process status (rather than just current HARQ process status). For example, the reported HARQ codebook may always include the last 4 HARQ process status rather than just 1 HARQ process. That is, the status of a particular TB may be repeated more than once. Accordingly, by applying the third proposed scheme of the present disclosure, the reliability issue caused by PUCCH false alarm in legacy HARQ status reporting may be solved and robustness of similar status report as in legacy RLC may be maintained.

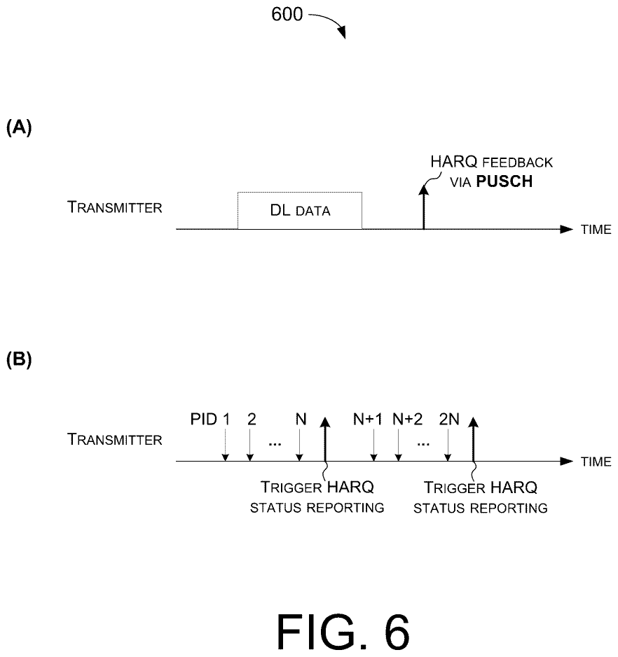

FIG. 6 illustrates an example scenario 600 of enhancements on HARQ feedback reliability in accordance with an implementation of the present disclosure. Part (A) of FIG. 6 depicts the PUSCH-based HARQ status reporting, while part (B) of FIG. 6 depicts an event-based triggering of the PUSCH-based HARQ status reporting (e.g., based on the use of every N^{th} HARQ process to provide the status of the last N HARQ processes).

### Illustrative Implementations

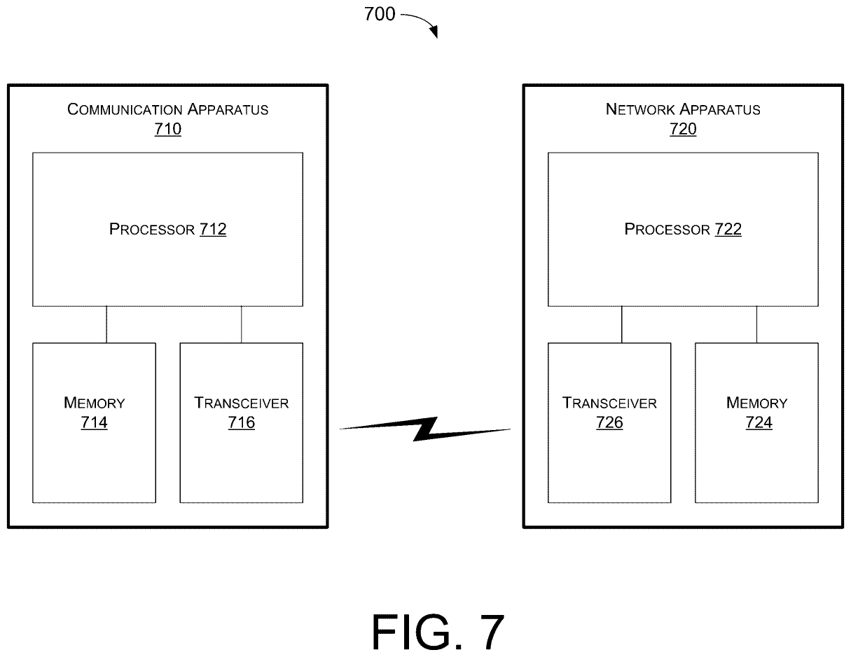

FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to supporting a semi-hybrid retransmission mechanism in mobile communications, including scenarios/schemes described above as well as processes 800, 900, and 1000 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 710 may also be a part of a machine type apparatus, which may be an IoT, NB-IoT, enhanced machine-type communication (eMTC), IIoT UE such as an immobile or a stationary apparatus, a home apparatus, a roadside unit (RSU), a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed schemes of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of an electronic apparatus, which may be a network node such as a satellite, a BS, a small cell, a router or a gateway of an IoT network. For instance, network apparatus 720 may be implemented in a satellite or an eNB/gNB/TRP in a 4G/5G, NR, IoT, NB-IoT or IIoT network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks, including supporting a semi-hybrid retransmission mechanism, in a device (e.g., as represented by communication apparatus 710) and a network node (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, transceiver 716 may be capable of wirelessly communicating with different types of UEs and/or wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, network apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, communication apparatus 710 may further include a memory 714 coupled to processor 712 and capable of being accessed by processor 712 and storing data therein. In some implementations, network apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 710 and network apparatus 720 may be a communication entity capable of communicating with each other using various proposed schemes in accordance with the present disclosure. For illustrative purposes and without limitation, a description of capabilities of communication apparatus 710, as a UE, and network apparatus 720, as a network node (e.g., BS/DU/CU/satellite), is provided below.

According to certain schemes of the present disclosure, processor 712 of communication apparatus 710 may perform, via transceiver 716, an UL transmission of at least one first TB associated with at least one HARQ process to network apparatus 720 for the HARQ process using the first TB. Then, processor 712 may receive, via transceiver 716, feedback information corresponding to the UL transmission from network apparatus 720. After that, processor 712 may perform, via transceiver 716, an UL retransmission of data from the first TB to network apparatus 720 using a second TB in an event that the feedback information indicates the UL transmission being unsuccessful and indicates a non-HARQ type of retransmission.

In some implementations, the second TB may include a subset of data from the first TB.

In some implementations, processor 712 may also store rest of the data from the first TB, which is not part of the subset, to a transmit buffer for subsequent UL transmission.

In some implementations, the second TB may be different in size from the first TB. In case the second TB is smaller than the first TB, only a subset of data from the first TB would be included in the second TB. In case the second TB is larger than the first TB, part or all of the data from the first TB along with new data can be included in the second TB.

In some implementations, processor 712 may also discard some of the data from the first TB, which exceeds a delay budget.

In some implementations, multiple HARQ processes and multiple HARQ buffers may be shared across carriers.

In some implementations, processor 712 may also receive, via transceiver 716, one or more DL transmissions associated with one or more HARQ processes from network apparatus 720. Additionally, processor 712 may transmit, via transceiver 716, one or more HARQ status reports corresponding to the one or more DL transmissions to network apparatus 720 via a PUSCH.

According to certain schemes of the present disclosure, processor 722 of network apparatus 720 may schedule, via transceiver 726, to communication apparatus 710 an UL transmission of at least one first TB associated with at least one HARQ process. Also, processor 722 may receive, via transceiver 726, the UL transmission from communication apparatus 710 for the HARQ process using the first TB. Then, processor 722 may transmit, via transceiver 726, feedback information corresponding to the UL transmission to communication apparatus 710, wherein the feedback information indicates the UL transmission being unsuccessful and indicates a non-HARQ type of retransmission. After that, processor 722 may receive, via transceiver 726, an UL retransmission from communication apparatus 710 of data from the first TB using a second TB.

In some implementations, the second TB may include a subset of data from the first TB.

In some implementations, the second TB may be different in size from the first TB. In case the second TB is smaller than the first TB, only a subset of data from the first TB would be included in the second TB. In case the second TB is larger than the first TB, part or all of the data from the first TB along with new data can be included in the second TB.

In some implementations, processor 722 may also determine the feedback information to indicate the non-HARQ type of retransmission in an event that a channel degradation or a network congestion is detected or simply the a maximum number of a HARQ type of retransmissions have been attempted for the first TB.

In some implementations, multiple HARQ processes and multiple HARQ buffers may be shared across carriers.

In some implementations, processor 722 may also perform, via transceiver 726, one or more DL transmissions associated with one or more HARQ processes to communication apparatus 710. Additionally, processor 722 may receive, via transceiver 726, one or more HARQ status reports corresponding to the one or more DL transmissions from communication apparatus 710 via a PUSCH.

According to certain schemes of the present disclosure, processor 722 of network apparatus 720 may schedule, via transceiver 726, to communication apparatus 710 a DL transmission of at least one first TB associated with at least one HARQ process. Also, processor 722 may perform, via transceiver 726, the DL transmission to communication apparatus 710 for the HARQ process using the first TB. Then, processor 722 may receive, via transceiver 726, feedback information corresponding to the DL transmission from communication apparatus 710, wherein the feedback information indicates the DL transmission being unsuccessful. After that, processor 722 may perform, via transceiver 726, a DL retransmission to communication apparatus 710 of data from the first TB using a second TB in an event that at least one condition is met.

In some implementations, the condition may include at least one of the following: (i) a channel degradation is detected; and (ii) a network congestion is detected; and (iii) a maximum number of a HARQ type of retransmissions of the first TB has been attempted.

In some implementations, the second TB may include a subset of data from the first TB.

In some implementations, processor 722 may also store rest of the data from the first TB, which is not part of the subset, to a transmit buffer for subsequent DL transmission. Alternatively, processor 722 may discard some of the data from the first TB, which exceeds a delay budget.

In some implementations, the second TB may be different in size than the first TB. In case the second TB is smaller than the first TB, only a subset of data from the first TB would be included in the second TB. In case the second TB is larger than the first TB, part or all of the data from the first TB along with new data can be included in the second TB.

In some implementations, multiple HARQ processes and multiple HARQ buffers may be shared across carriers.

In some implementations, the feedback information may be received in one or more HARQ status reports corresponding to one or more DL transmissions via a PUSCH.

### Illustrative Processes

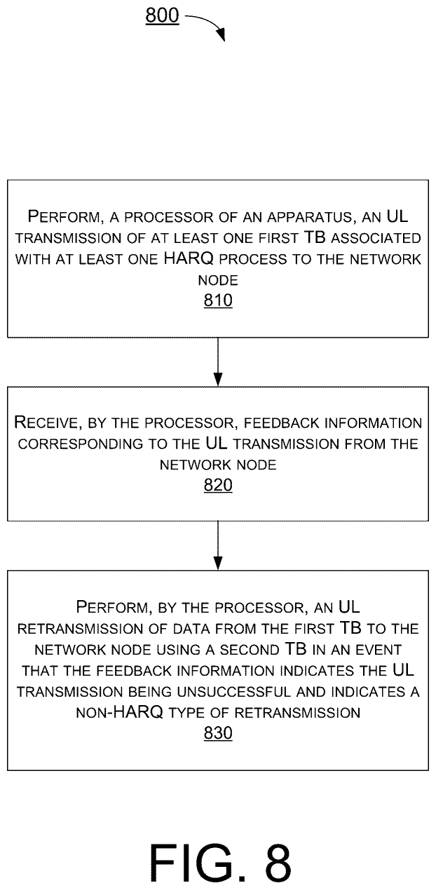

FIG. 8 illustrates an example process 800 in accordance with an implementation of the present disclosure. Process 800 may be an example implementation of above scenarios/schemes, whether partially or completely, with respect to supporting a semi-hybrid retransmission mechanism in mobile communications. Process 800 may represent an aspect of implementation of features of communication apparatus 710. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by communication apparatus 710 or any suitable UE or machine type devices. Solely for illustrative purposes and without limitation, process 800 is described below in the context of communication apparatus 710. Process 800 may begin at block 810.

At 810, process 800 may involve processor 712 of communication apparatus 710 performing, via transceiver 716, an UL transmission of at least one first TB associated with at least one HARQ process to the network node (e.g., network apparatus 720). Process 800 may proceed from 810 to 820.

At 820, process 800 may involve processor 712 receiving, via transceiver 716, feedback information corresponding to the UL transmission from the network node. Process 800 may proceed from 820 to 830.

At 830, process 800 may involve processor 712 performing, via transceiver 716, an UL retransmission of data from the first TB to the network node using a second TB in an event that the feedback information indicates the UL transmission being unsuccessful and indicates a non-HARQ type of retransmission.

In some implementations, the second TB may include a subset of data from the first TB.

In some implementations, process 800 may further involve processor 712 storing rest of the data from the first TB, which is not part of the subset, to a transmit buffer for subsequent UL transmission.

In some implementations, the second TB may be different in size from the first TB.

In some implementations, process 800 may further involve processor 712 discarding some of the data from the first TB, which exceeds a delay budget.

In some implementations, multiple HARQ processes and multiple HARQ buffers may be shared across carriers.

In some implementations, process 800 may further involve processor 712 receiving, via transceiver 716, one or more DL transmissions associated with one or more HARQ processes from the network node. Additionally, process 800 may involve processor 712 transmitting, via transceiver 716, one or more HARQ status reports corresponding to the one or more DL transmissions to the network node via a PUSCH.

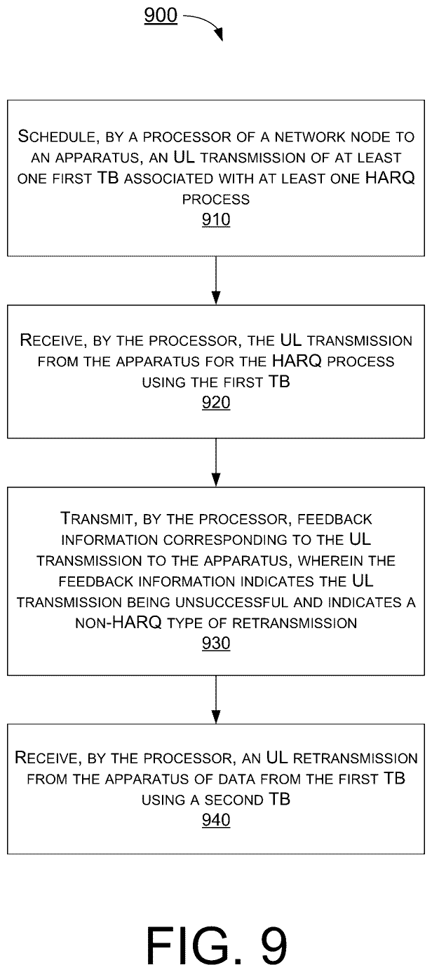

FIG. 9 illustrates an example process 900 in accordance with an implementation of the present disclosure. Process 900 may be an example implementation of above scenarios/schemes, whether partially or completely, with respect to supporting a semi-hybrid retransmission mechanism in mobile communications. Process 900 may represent an aspect of implementation of features of network apparatus 720. Process 900 may include one or more operations, actions, or functions as illustrated by one or more of blocks 910 to 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 720 or any suitable BS/DU/CU or satellite. Solely for illustrative purposes and without limitation, process 900 is described below in the context of network apparatus 720. Process 900 may begin at block 910.

At 910, process 900 may involve processor 722 of network apparatus 720 scheduling, via transceiver 726, to an apparatus (e.g., communication apparatus 710) an UL transmission of at least one first TB associated with at least one HARQ process. Process 900 may proceed from 910 to 920.

At 920, process 900 may involve processor 722 receiving, via transceiver 726, the UL transmission from the apparatus for the HARQ process using the first TB. Process 900 may proceed from 920 to 930.

At 930, process 900 may involve processor 722 transmitting, via transceiver 726, feedback information corresponding to the UL transmission to the apparatus, wherein the feedback information indicates the UL transmission being unsuccessful and indicates a non-HARQ type of retransmission. Process 900 may proceed from 930 to 940.

At 940, process 900 may involve processor 722 receiving, via transceiver 726, an UL retransmission from the apparatus of data from the first TB using a second TB.

In some implementations, the second TB may include a subset of data from the first TB.

In some implementations, the second TB may be different in size from the first TB.

In some implementations, process 900 may further involve processor 722 determining the feedback information to indicate the non-HARQ type of retransmission in an event that a channel degradation or a network congestion is detected, or that a maximum number of a HARQ type of retransmissions of the first TB are attempted.

In some implementations, multiple HARQ processes and multiple HARQ buffers may be shared across carriers.

In some implementations, process 900 may further involve processor 722 performing, via transceiver 726, one or more DL transmissions associated with one or more HARQ processes to the apparatus. Additionally, process 900 may involve processor 722 receiving, via transceiver 726, one or more HARQ status reports corresponding to the one or more DL transmissions from the apparatus via a PUSCH.

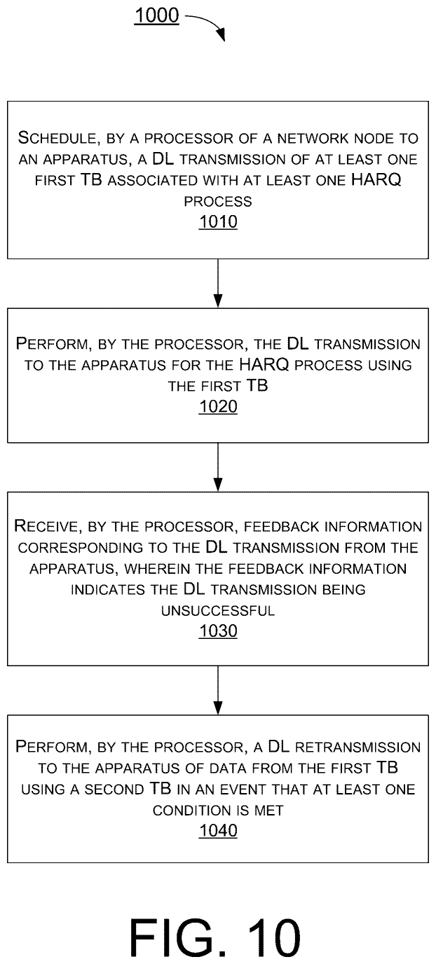

FIG. 10 illustrates an example process 1000 in accordance with an implementation of the present disclosure. Process 1000 may be an example implementation of above scenarios/schemes, whether partially or completely, with respect to supporting a semi-hybrid retransmission mechanism in mobile communications. Process 1000 may. represent an aspect of implementation of features of network apparatus 720. Process 1000 may include one or more operations, actions, or functions as illustrated by one or more of blocks 1010 to 1040. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 720 or any suitable BS/DU/CU or satellite. Solely for illustrative purposes and without limitation, process 1000 is described below in the context of network apparatus 720. Process 1000 may begin at block 1010.

At 1010, process 1000 may involve processor 722 of network apparatus 720 scheduling, via transceiver 726, to an apparatus (e.g., communication apparatus 710) a DL transmission of at least one first TB associated with at least one HARQ process. Process 1000 may proceed from 1010 to 1020.

At 1020, process 1000 may involve processor 722 performing, via transceiver 726, the DL transmission to the apparatus for the HARQ process using the first TB. Process 1000 may proceed from 1020 to 1030.

At 1030, process 1000 may involve processor 722 receiving, via transceiver 726, feedback information corresponding to the DL transmission from the apparatus, wherein the feedback information indicates the DL transmission being unsuccessful. Process 1000 may proceed from 1030 to 1040.

At 1040, process 1000 may involve processor 722 performing, via transceiver 726, a DL retransmission to the apparatus of data from the first TB using a second TB in an event that at least one condition is met.

In some implementations, the condition may include at least one of the following: (i) a channel degradation is detected; and (ii) a network congestion is detected; and (iii) a maximum number of a HARQ type of retransmissions of the first TB have been attempted.

In some implementations, the second TB may include a subset of data from the first TB.

In some implementations, process 1000 may further involve processor 722 storing rest of the data from the first TB, which is not part of the subset, to a transmit buffer for subsequent DL transmission. Alternatively, process 1000 may involve processor 722 discarding some of the data from the first TB, which exceeds a delay budget.

In some implementations, the second TB may be different in size from the first TB.

In some implementations, multiple HARQ processes and multiple HARQ buffers may be shared across carriers.

In some implementations, the feedback information may be received in one or more HARQ status reports corresponding to one or more DL transmissions via a PUSCH.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, an UL transmission of at least one first transport block (TB) associated with at least one hybrid automatic repeat request (HARQ) process to a network node;
receiving, by the processor, feedback information corresponding to the UL transmission from the network node; and
performing, by the processor, an UL retransmission of data from the first TB to the network node using a second TB in an event that the feedback information indicates the UL transmission being unsuccessful and indicates a non-HARQ type of retransmission.

2. The method of claim 1, wherein the second TB is different in size from the first TB.

3. The method of claim 1, wherein the second TB comprises a subset of data from the first TB.

4. The method of claim 3, further comprising:
storing, by the processor, rest of the data from the first TB, which is not part of the subset, to a transmit buffer for subsequent UL transmission.

5. The method of claim 3, further comprising:
discarding, by the processor, some of the data from the first TB, which exceeds a delay budget.

6. The method of claim 1, wherein multiple HARQ processes and multiple HARQ buffers are shared across carriers.

7. The method of claim 1, further comprising:
receiving, by the processor, one or more downlink (DL) transmissions associated with one or more HARQ processes from the network node; and
transmitting, by the processor, one or more HARQ status reports corresponding to the one or more DL transmissions to the network node via a physical uplink shared channel (PUSCH).

8. A method, comprising:
scheduling, by a processor of a network node to an apparatus, an uplink (UL) transmission of at least one first transport block (TB) associated with at least one hybrid automatic repeat request (HARQ) process;
receiving, by the processor, the UL transmission from the apparatus for the HARQ process using the first TB;
transmitting, by the processor, feedback information corresponding to the UL transmission to the apparatus, wherein the feedback information indicates the UL transmission being unsuccessful and indicates a non-HARQ type of retransmission; and
receiving, by the processor, an UL retransmission from the apparatus of data from the first TB using a second TB.

9. The method of claim 8, wherein the second TB comprises a subset of data from the first TB.

10. The method of claim 8, wherein the second TB is different in size from the first TB.

11. The method of claim 8, further comprising:
determining, by the processor, the feedback information to indicate the non-HARQ type of retransmission in an event that a channel degradation or a network congestion is detected, or that a maximum number of a HARQ type of retransmissions of the first TB are attempted.

12. The method of claim 8, wherein multiple HARQ processes and multiple HARQ buffers are shared across carriers.

13. The method of claim 8, further comprising:
performing, by the processor, one or more downlink (DL) transmissions associated with one or more HARQ processes to the apparatus; and
receiving, by the processor, one or more HARQ status reports corresponding to the one or more DL transmissions from the apparatus via a physical uplink shared channel (PUSCH).

14. A method, comprising:
scheduling, by a processor of a network node to an apparatus, a downlink (DL) transmission of at least one first transport block (TB) associated with at least one hybrid automatic repeat request (HARQ) process;
performing, by the processor, the DL transmission to the apparatus for the HARQ process using the first TB;
receiving, by the processor, feedback information corresponding to the DL transmission from the apparatus, wherein the feedback information indicates the DL transmission being unsuccessful; and
performing, by the processor, a DL retransmission to the apparatus of data from the first TB using a second TB in an event that at least one condition is met.

15. The method of claim 14, wherein the condition comprises at least one of the following:
a channel degradation is detected; and
a network congestion is detected; and
a maximum number of a HARQ type of retransmissions of the first TB is attempted.

16. The method of claim 14, wherein the second TB comprises a subset of data from the first TB.

17. The method of claim 16, further comprising:
storing, by the processor, rest of the data from the first TB, which is not part of the subset, to a transmit buffer associated with the HARQ process for subsequent DL transmission; or
discarding, by the processor, some of the data from the first TB, which exceeds a delay budget.

18. The method of claim 14, wherein the second TB is different in size from the first TB.

19. The method of claim 14, wherein multiple HARQ processes and multiple HARQ buffers are shared across carriers.

20. The method of claim 14, wherein the feedback information is received in one or more HARQ status reports corresponding to one or more DL transmissions via a physical uplink shared channel (PUSCH).
